(19) United States
(12) Patent Application Publication
(10) Pub. No.: US 2024/0227038 A1
(43) Pub. Date: Jul. 11, 2024

(54) A COMBINATION DRILL BIT AND BIT DRIVER DEVICE

(71) Applicant: ANCHIQUE PTY LTD, Cronulla, New South Wales (AU)

(72) Inventor: German ANCHIQUE, Cronulla (AU)

(21) Appl. No.: 18/559,000

(22) PCT Filed: Mar. 28, 2022
(86) PCT No.: PCT/AU2022/050278

§ 371 Date: Nov. 3, 2023

(30) Foreign Application Priority Data
May 11, 2021 (AU) 2021901388
Jun. 11, 2021 (AU) 2021901763

(51) Int. Cl. B23B 51/08; B23B 51/02

(52) U.S. Cl. CPC B23B 51/08; B23B 51/02

(57) ABSTRACT

A drill bit comprising: a tubular shaft having a cutting tip at a first end and a drive shank at a second end, wherein the drive shank is adapted to engage with a drive motor, and wherein the cutting tip comprises an axially protruding shape. A first flute portion positioned between the cutting tip and the drive shank, wherein the first flute portion includes a first thread with a first sharpened cutting edge in a first helix; and wherein the first end of the cutting tip has a point angle greater than 135 degrees, and the cutting tip includes a cutting surface that joins to the first thread, and wherein the cutting tip act as a bit driver and has a profile, when viewed axially from the first end has one shape type.

### TECHNICAL FIELD

The present invention relates to a combination drill bit and bit driver device. More particularly, the present disclosure may relate to a device for use in forming holes in wooden material as well as for use in driving fasteners of certain type shapes.

### BACKGROUND

Typical affixing of wallboard material together requires the drilling of holes to receive screw anchors to be used with screws for securing backplates, the drilling of a larger hole to allow connection of the backplate, and the driving of screws into the screw anchors to secure the backplate. In the past, this procedure required the worker to handle several tools including a drill bit for forming the holes for the screw anchors, a larger drill bit for forming a countersink, and a screwdriver bit for driving the screws into the screw anchors to secure the backplate. A disadvantage with this previous procedure is that the changing of the individual tools for different purposes was time-intensive and time inefficient. Further, another disadvantage with forming different sized holes using two separate tools may increase human error of having the holes not perfectly aligned. Moreover, assuming that only a drill is used, the smaller drill bit has to changed with a larger drill bit and vice versa to create a different hole size. The frequent changing of drill bits may increase the chance of worker injury.

For worker's convenience, combination tools have been integrally developed, such as a drill and countersink tool described in U.S. Pat. No. 2,978,846; a combination drill and screwdriver tool described in GB2350075; a combination threading and screwdriver tool described in U.S. Pat. No. 3,869,741; a combination drill and screwdriver tool described in U.S. Pat. No. 4,852,196. While convenient, a general disadvantage with the one-size-fits-all for these tools is that it cannot cater the drill size to the material or application. With more combinations in the tool, as drill bits are integrally formed as one piece, there are more combination of length and diameter variables to consider including the suitability of the drill bit used for the particular material to be drilled, which may not have standardised dimensions. In light of the aforementioned disadvantages, there exists a long-felt need to provide a combination drill bit and bit driver device that may overcome one or more shortcomings of combination tools as described in the prior art.

Any discussion of the prior art throughout the specification should in no way be considered as an admission that such prior art is widely known or forms part of common general knowledge in the field.

### SUMMARY

### Problems to be Solved

It may be an advantage to provide a drill bit with the cutting tip acting as a bit driver for worker's convenience.

It may also be an advantage to further provide a drill bit with a flute portion for creating a pilot hole in the material, in which the flute portion may have a thread with a sharpened cutting edge in a helix for efficient material removal.

It may also be an advantage to further provide a drill bit with a countersink cutting member secured to the flute portion for allowing the head of the fastener to sit flush with or below the surface of the drilled material.

It may be an advantage to provide a cutting tip with a flatter point angle of greater than 135 degrees to allow for more efficient cutting edge engaging with the material surface sooner to begin the cutting action.

It may be an advantage to use standard cross-sectional dimensions of lumber or timber such that thickness and width of the piece are predictably sized for choosing the right drill bit with the right length for the work.

It may be an advantage to provide the drill bit having different combinations lengths to allow for different depth of drilling in bespoke dimensions of lumber or timber.

It may be an advantage to provide a range of helical angles for the flute portion(s) of the drill bit to accommodate drilling into materials which may range between soft to hard materials.

It may be an advantage to select a thread with higher range helix angles with a short spiral to use on soft materials such as light metals including aluminium and copper, soft plastics, hardwood, and chipboard. The helix angle may be bigger, thus allowing chips to flow off easily.

It may be an advantage to select a thread with a middle range helix angle with a normal spiral to use on structural steels, non-ferrous metals, cast iron.

It may be an advantage to select a thread with a very small helix angle with a lengthy spiral to use on hard materials such as steel (brass), hard plastic, laminates, and perspex.

It may be an advantage to provide a quick-release bit holder in the drive shank section, such as a hex head which may be received in and secured by a hex impact drive motor or driver. Having a bit holder provides for a more secure and centred engagement with the driver for drilling.

It may be an advantage to provide chamfered lines between the periphery of the cutting tip shape, when viewed axially above from the first end so that there is more sharpened area for the cutting tip to drill into the material, and further, the chamfered sides adjacent to the lines provide a slope at the cutting tip to assist the wooden material chips to flow off from the cutting tip easily when drilling.

It is an object of the present invention to overcome or ameliorate at least one of the disadvantages of the prior art, or to provide a useful alternative.

### Means for Solving the Problem

A first aspect of the present invention may relate to a drill bit comprising: a tubular shaft having a cutting tip at a first end and a drive shank at a second end, wherein the drive shank is adapted to engage with a drive motor, and wherein the cutting tip comprises an axially protruding shape; a first flute portion positioned between the cutting tip and the drive shank, wherein the first flute portion includes a first thread with a first sharpened cutting edge in a first helix; and wherein the first end of the cutting tip has a point angle greater than 135 degrees, and the cutting tip includes a cutting surface that joins to the first thread, and wherein the cutting tip act as a bit driver and has a profile, when viewed axially from the first end has one shape type selected from the following group of: hex, square, pentagon, hexlobe, hex key, TA, tri-point, tri-wing, clutch, polydrive, bistol, and spline.

Preferably, the drill bit comprises a countersink cutting member secured to the first flute portion of a first diameter, wherein the countersink cutting member includes a second diameter larger than the first diameter and wherein the edge of the countersink cutting member proximal to the first end is sharpened.

Preferably, the drill bit comprises a second flute portion secured between the first flute portion of a first diameter and a countersink cutting member of a second diameter, wherein the second flute portion includes a second thread with a second sharpened cutting edge in a second helix, and wherein the second flute portion includes a third diameter larger than the first diameter and smaller than the second diameter, and wherein the edge of the countersink cutting member proximal to the first end is sharpened.

Preferably, the countersink cutting member comprises a counterbore cutting member positioned between the countersink cutting member and the drive shank.

Preferably, the diameter of the counterbore cutting member is in the range of: 3.5 mm to 75.0 mm.

Preferably, the depth of the counterbore cutting member is in the range of: 1.6 mm to 48.0 mm.

Preferably, the diameter of the countersink cutting member is the in range of: 2.0 mm to 52.6 mm.

Preferably, the length of the countersink cutter is in the range of: 1.6 mm to 16 mm.

Preferably, the length of the first flute portion is in the range of: 19 mm to 120 mm.

Preferably, the drive shank comprises a quick-release bit holder.

Preferably, the drill bit is composed of one material selected from the following group of: carbon steel, and tungsten carbide.

Preferably, the first helix and the second helix is an angle chosen between the range of 10° to 45°.

Preferably, the first helix of the first flute portion has a different helix angle to the second helix of the second flute portion.

Preferably, the shape of the cutting tip comprises chamfered lines between the periphery of the cutting tip shape, when viewed axially above from the first end.

Preferably, a washer is positioned between the countersink cutting member and the drive shank.

Preferably, a washer is positioned between the counterbore cutting member and the drive shank.

Preferably, the washer having a first surface distal to the drive shank, and a second surface proximal to the drive shank, wherein the first surface is low surface friction.

Preferably, the first surface of the washer is one material chosen from the group of: nylon, plastic, and Teflon

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts a side view schematic of a combination drill bit and bit driver with a cutting tip with a fluted portion for creating a clearance hole.

FIG. 2 depicts a side view schematic of a combination drill bit and bit driver with a cutting tip with a first fluted portion for creating a pilot hole, and a second fluted portion for creating a clearance hole.

FIG. 3 depicts a side view schematic of a combination drill bit and bit driver with a cutting tip with a first fluted portion for creating a pilot hole, and a countersink cutting member and a counterbore cutting member.

FIG. 4 depicts a side view schematic of a combination drill bit and bit driver with a cutting tip with a first fluted portion for creating a pilot hole, a second fluted portion for creating a clearance hole, and a countersink cutting member and a counterbore cutting member.

FIG. 5A depicts a point cutter with an axially projected shape of a preferred embodiment.

FIG. 5B depicts a point cutter with another axially projected shape of a preferred embodiment.

FIG. 5C depicts a point cutter with another axially projected shape of a preferred embodiment.

FIG. 5D depicts a point cutter with another axially projected shape of a preferred embodiment.

FIG. 5E depicts a point cutter with another axially projected shape of a preferred embodiment.

FIG. 6 is a perspective view schematic of the cutting tip end of the drill bit showing the angle to suit the head of a fastener.

FIG. 7 is a top view schematic of the cutting tip end of the drill bit of FIG. 6.

FIG. 8 is a schematic showing the top view of the drive shank of a preferred embodiment when viewed axially above.

FIG. 9 is a schematic showing the top view of the drive shank of another preferred embodiment when viewed axially above.

FIG. 10A depicts a head of a fastener with a shape for use in securing two wooden materials. This shape will be used with a bit driver with a cutting tip having a shape of FIG. 5B.

FIG. 10B depicts a head of a fastener with another shape for use in securing two wooden materials. This shape will be used with a bit driver with a cutting tip having a shape of FIG. 5A.

FIG. 10C depicts a head of a fastener with another shape for use in securing two wooden materials. This shape will be used with a bit driver with a cutting tip having a shape of FIG. 5C.

FIG. 10D depicts a head of a fastener with another shape for use in securing two wooden materials. This shape will be used with a bit driver with a cutting tip having a shape of FIG. 5D.

FIG. 10E depicts a head of a fastener with another shape for use in securing two wooden materials. This shape will be used with a bit driver with a cutting tip having a shape of FIG. 5E.

FIG. 11 is a perspective view of the combination drill bit and bit driver device showing the cutting tip and a fluted portion.

FIG. 12 is a perspective view of a combination drill bit and bit driver device secured to a driver.

FIG. 13 is a perspective view of a combination drill bit and bit driver device secured to a driver, when in use.

FIG. 14 depicts a side view schematic of a combination drill bit and bit driver a cutting tip with a first fluted portion for creating a pilot hole, and a cutting member with non-friction washer positioned between the countersink cutting member and the drive shank.

### DESCRIPTION OF THE INVENTION

Preferred embodiments of the invention will now be described with reference to the accompanying drawings and non-limiting examples.

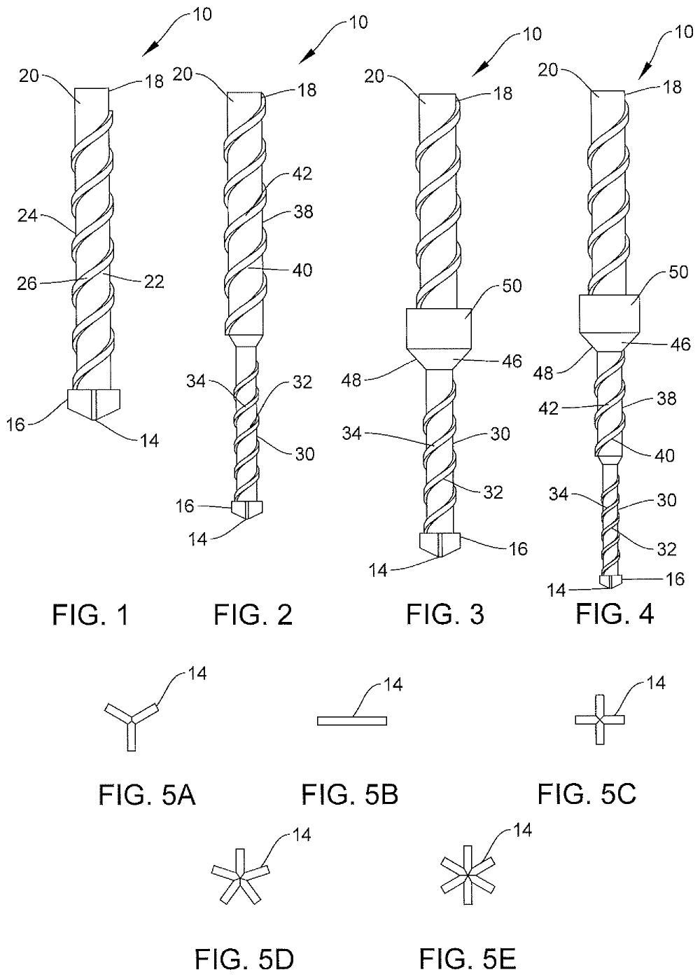

Embodiments of the present invention, as illustrated in FIGS. 1 to 4, the drill bit 10 may have a tubular shaft 12 having a cutting tip 14 at a first end 16 and a drive shank 18 at a second end 20. The cutting tip 14 may act as a bit driver and has a profile, when viewed axially from the first end has one shape type selected from the following group of: hex, square, pentagon, hexlobe, hex key, TA, tri-point, tri-wing, clutch, polydrive, bistol, and spline. The tubular shaft may have a profile of a circle, a square, or a hexagon when viewed axially from the second end 20. The drive shank 18 may be an elongate member that may be engaged in the jaws of a keyless chuck of a drive motor or the drive shank 18 may have a quick-release bit holder, such as a hex head which may be received in and secured by a hex impact drive motor or driver. The drive motor may provide torque to the drill bit which may be used to creating holes in the material in one use or securing or removing a fastener in another use.

As illustrated in FIG. 1, between the cutting tip 14 and the drive shank 18, there may be a fluted portion 22 which includes a thread 24 with a sharpened cutting edge 26 arranged in a helix 28. Depending on the hardness of the material, the helical angle of the fluted portion may be chosen between 10° to 45°. The embodiment as shown in FIG. 1 may be used to drill a clearance hole in the material.

In another embodiment of the present invention, as illustrated in FIG. 2, a first fluted portion 30 is positioned between a cutting tip 14 and a second fluted portion 38. The first flute portion 30 may include a first thread 32 with a first sharpened cutting edge 34 arranged in a first helix 36, and the second flute portion 38 may also include a second thread 40 with a second sharpened cutting edge 42 arranged in a second helix 44. The first flute portion 30 may have a first diameter and the second flute portion 38 may have a second diameter. As the first flute portion 30 may create a pilot hole in a first material, and the second flute portion 38 may create a clearance hole in a second material, it may be appreciated that the first diameter is relatively smaller than the second diameter. The first material and the second material may be a material chosen from the group of: aluminium and copper, soft plastics, softwood, hardwood, and chipboard, structural steels, non-ferrous metals, cast iron, steel (brass), hard plastic, laminates, and Perspex.

Generally, joining two different materials together with a fastener in construction may involve using two materials that are similar to each other. Such as, joining a timber piece with another similar timber piece. For similar timber pieces, the first helix 36 and the second helix 44 may have a same or similar helix angle. For joining a first timber piece with a second timber piece of a different hardness relative to the first timber piece, the first helix 36 and the second helix 44 may not have the same or similar helix angle. A thread with higher range helix angles (27° to 45°) with a short spiral to use on softer materials, and a thread with small range helix angles (10° to 19°) with a lengthy spiral may be more applicable with harder wood. It may be appreciated that the drill bit may have a first flute portion with a lengthy spiral and a second flute portion with a short spiral or a drill bit may have a first flute portion with a short spiral or a lengthy spiral.

In another embodiment of the present invention, as illustrated in FIG. 3, a drill bit 10 may comprise a countersink cutting member 46 secured to the first flute portion 30 of a diameter, wherein the countersink cutting member 46 includes a diameter larger than the diameter of the first flute portion and wherein the edge 48 of the countersink cutting member 46 proximal to the first end 16 is sharpened. The countersink cutting member 46 may comprise a counterbore cutting member 50 positioned between the countersink cutting member 46 and the drive shank 18. It may be an advantage to provide a pilot hole from drilling the material using the first flute portion 30 and have a countersink, which is a bigger hole to allow the head of the fastener such as a screw to be flush with the drilled material. It may be a further advantage to provide a counterbore so as to create a deeper countersink for a bigger head of the fastener, such as a hex head, for example; to be flush with the drilled material. Similarly, depending on the hardness of the material, the helix angle of the flute portion may be selected accordingly. Also, depending on the depth at which the hole is created, the length of the flute portion may be predetermined. This predetermined length may be most suitable for use in standard dimensioned timber, for example.

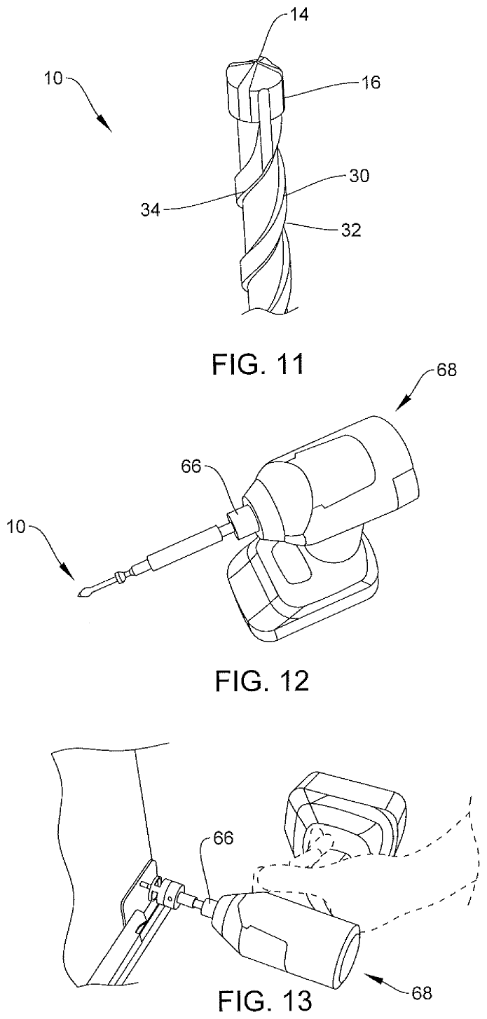

In another embodiment of the present invention, as illustrated in FIG. 4, a drill bit 10 may comprise a tubular shaft 12 having a cutting tip 14 at a first end 16 and a drive shank 18 at a second end 20, wherein the drive shank 18 is adapted to engage with a drive motor, and wherein the cutting tip 14 comprises an axially protruding shape. There may be a first flute portion 30 positioned between the cutting tip 14 and the drive shank 18 and there may be a second flute portion 38 positioned between the first flute portion 30 and the drive shank 18. The first flute portion 30 may include a first thread 32 with a first sharpened cutting edge 34 arranged in a first helix 36, and the second flute portion 38 may also include a second thread 40 with a second sharpened cutting edge 42 arranged in a second helix 44. For example, a representative flute portion of the drill bit 10 is shown in FIG. 11. As shown in FIG. 4, the first flute portion 30 may be secured to second flute portion 38. The first flute portion 30 may have a first diameter and the second flute portion 38 may have a second diameter. As the first flute portion 30 may create a pilot hole in a first material, and the second flute portion 38 may create a clearance hole in a second material, it may be appreciated that the first diameter is relatively smaller than the second diameter. The first end of the cutting tip 14 may have a point angle greater than 135 degrees, and the cutting tip 14 may include a cutting surface that joins to the first thread 32, and wherein the cutting tip 14 may act as a bit driver and may have a profile, which when viewed axially from the first end 16 may have one shape type selected from the following group of: hex, square, pentagon, hexlobe, hex key, TA, tri-point, tri-wing, clutch, polydrive, bistol, and spline. There may also be a countersink cutting member 46 positioned between the second flute portion 38 and the drive shank 18, in which the edge 48 of the countersink cutting member 46 proximal to the first end is sharpened. The drill bit may further comprise a counterbore cutting member 50 positioned between the countersink cutting member 46 and the drive shank 18.

It may be appreciated that for standard dimensioned timber, in which the width and depth are consistent, the flute portions 30, 38 may have a suitable length to drill a pilot hole into one standard dimensioned timber, and a clearance hole into another standard dimensioned timber. It may also be appreciated that the diameters of the flute portions will accommodate the diameters of standard fasteners.

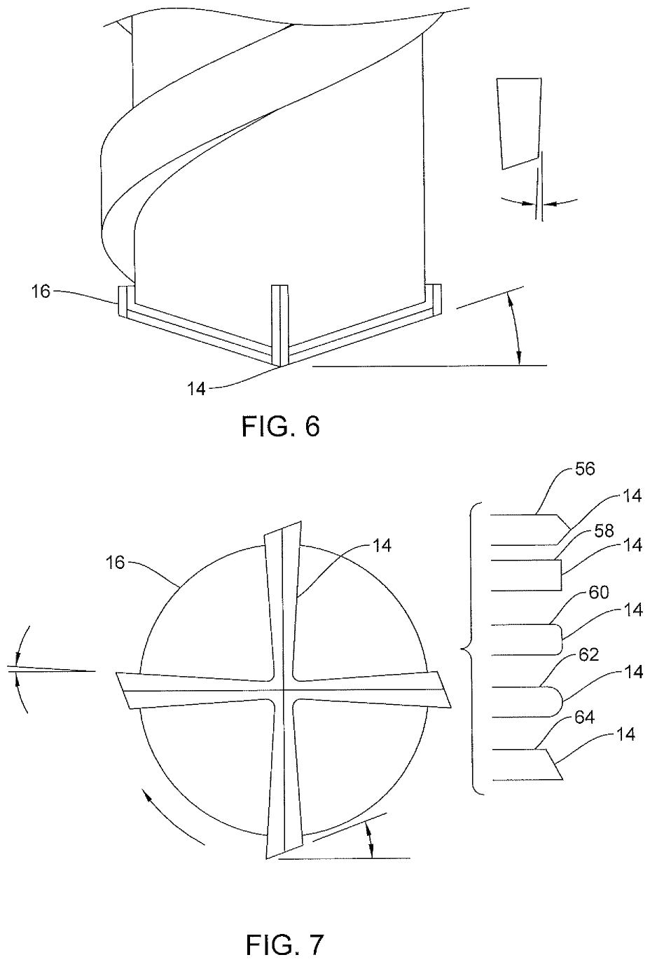

The axially protruding shape of the cutting tip 14 are chosen from the shapes as illustrated in FIGS. 5A to 5E depending on the screw heads shapes as shown in FIG. 10A to 10E. It may be an advantage to provide chamfered lines between the periphery of the cutting tip shape, when viewed axially above from the first end so that there is more sharpened area for the cutting tip to drill into the material, and further, the chamfered sides adjacent to the lines provide a slope at the cutting tip to assist the wooden material chips to flow off from the cutting tip easily when drilling. It may be appreciated that other shapes, while not shown, may be used that also can act as a bit driver. As illustrated in FIG. 6, the cutting tip 14 of the drill bit 10 may be squared or angled to suit the head 52 of screws or fasteners 54. As illustrated in FIG. 7, the cutting tip 14 may be one or any combination of: pointed 56, squared 58, small radiused 60, full radiused 62, or cutter shaped 64.

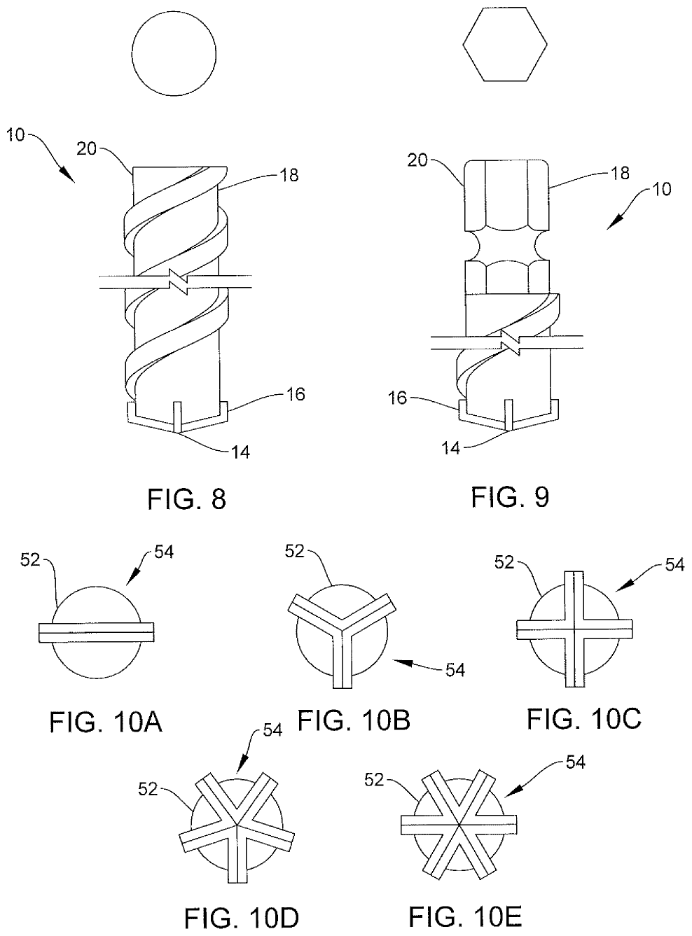

As illustrated in FIGS. 8 and 9, the tubular shaft may have a profile of a circle, a square, or a hexagon when viewed axially from drive shank 18 at the second end 20. As shown in FIG. 8, round or tubular shafts may be used to receiving in the jaws of the keyless chucks 66 of a drill motor 68, while as shown in FIG. 9, the drive shank 18 may have a quick-release bit holder, such as a hex head which may be received in and secured by a hex impact drive motor or driver 68. An example of a drill bit 10 secured in a drive motor 68 or drill 68 is shown in FIG. 12 and an example of a drill bit 10 in use with the driver motor 68 in creating holes in the wooden material is shown in FIG. 13.

To reduce the variables of length of the drill bit 10, and thereby reduce the extensive drill bit kit, it is an advantage to use dimensional timber, which is wood lumber that is cut to pre-defined, standard sizes. Dimensional lumber is sawn, planed, and sometimes further smoothed to make it immediately ready for many applications. Dimensional lumber is the most common type of lumber used for building because its consistent sizing allows builders to use it interchangeably throughout the home. Standardisation also means that builders or any ordinary persons doing it yourself are using lumber that is sized the same way, that is, the same depth and the same width. There may be other types of lumber, such as plywood and other wooden sheets, do come in prescribed standard sizes but are not referred to as dimensional lumber. As such, the length variable in the fluted portions to drill a pilot hole and clearance hole can be reduced to mainly accommodate the depth and width of either dimensional lumber or standard sized other lumber.

Examples of Dimensional Lumber sizes (Softwood and Harwood) is shown in Table 1.

Examples of Dimensional Lumber Sizes (Softwood and Hardwood)

| Inch name | Sawed | | Swedish | | Australian | |
|---|---|---|---|---|---|---|
| 2 × 4 | 50 × 100 | mm | 45 × 95 | mm | 45 × 90 | mm |
| 1 × 3 | 25 × 75 | mm | 22 × 70 | mm | 19 × 70 | mm |
| 3 × 3 | 75 × 75 | mm | 70 × 70 | mm | 70 × 70 | mm |
| 2 × 3 | 50 × 75 | mm | 45 × 70 | mm | 45 × 70 | mm |
| 1 × 4 | 25 × 100 | mm | 22 × 95 | mm | 19 × 90 | mm |
| 1 × 5 | 25 × 125 | mm | 22 × 120 | mm | 19 × 120 | mm |
| 2 × 5 | 50 × 125 | mm | 45 × 120 | mm | 45 × 120 | mm |

It may be appreciated that common width and depth of the dimensioned lumber is between 19 mm to 120 mm, the fluted portions of the drill bit may have a length of a value within this range. It may be appreciated that the dimensions in the above table is not exhaustive and there may be different dimension lumbers, while not disclosed in this table, may be also used. It is appreciated that to accommodate drilling of other dimension lumbers not listed, the fluted portions of the drill bit may be beyond the listed range.

For screws and/or hex head fasteners, the head may have a height between 1.6 mm to 16 mm. It may be appreciated that the countersink cutting member and counterbore cutting member may have a length to provide the head of fastener to sit flush in the drilled material. It may also be appreciated that the range is not exhaustive and there may be sized screw and/or hex head fasteners, which may be also used. It is appreciated that to accommodate these smaller or larger heads, the countersink cutting member and the counterbore cutting member may have a length beyond the listed range.

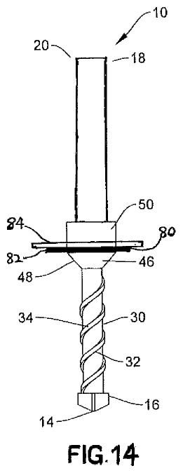

In another embodiment of the present invention, as illustrated in FIG. 14, a drill bit 10 may comprise a countersink cutting member 46 secured to the first flute portion 30 of a diameter, wherein the countersink cutting member 46 includes a diameter larger than the diameter of the first flute portion and wherein the edge 48 of the countersink cutting member 46 proximal to the first end 16 is sharpened. The countersink cutting member 46 may comprise a counterbore cutting member 50. Depending on whether a countersink hole or a countersink and a counterbore hole is required, it may be appreciated that a non-friction washer 80 may be positioned between the countersink cutting member 46 and the drive shank 18, as illustrated in FIG. 14, or it may be appreciated that a non-friction washer 80 may be positioned between the counterbore cutting member 50 and the drive shank 18 (not shown). It may be an advantage to have a drill bit 10 with a washer having a low friction surface to minimise drilling a deeper countersink/counterbore hole than intended/measured once the drill bit 10 reaches the washer of this embodiment of the drill bit 10. The washer or non-friction washer 810 may be have a first surface 82 distal to the drive shank 18, and a second surface 84 proximal to the drive shank 18. The first surface 82 may be low surface friction. It may be appreciated that the first surface 82 of the washer 80 is one low surface friction material chosen from the group of: nylon, plastic and Teflon.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A drill bit comprising:
a tubular shaft having a cutting tip at a first end and a drive shank at a second end, wherein the drive shank is adapted to engage with a drive motor, and wherein the cutting tip comprises an axially protruding shape;
a first flute portion positioned between the cutting tip and the drive shank, wherein the first flute portion includes a first thread with a first sharpened cutting edge in a first helix;
and wherein the first end of the cutting tip has a point angle greater than 135 degrees, and the cutting tip includes a cutting surface that joins to the first thread, and wherein the cutting tip act as a bit driver and has a profile, when viewed axially from the first end has one shape type selected from the following group of: hex, square, pentagon, hexlobe, hex key, TA, tri-point, tri-wing, clutch, polydrive, bistol, and spline.

2. The drill bit of claim 1, wherein the drill bit comprises a countersink cutting member secured to the first flute portion of a first diameter, wherein the countersink cutting member includes a second diameter larger than the first diameter and wherein the edge of the countersink cutting member proximal to the first end is sharpened.

3. The drill bit of claim 1, wherein the drill bit comprises a second flute portion secured between the first flute portion of a first diameter and a countersink cutting member of a second diameter, wherein the second flute portion includes a second thread with a second sharpened cutting edge in a second helix, and wherein the second flute portion includes a third diameter larger than the first diameter and smaller than the second diameter, and wherein the edge of the countersink cutting member proximal to the first end is sharpened.

4. The drill bit according to claim 3, wherein the countersink cutting member comprises a counterbore cutting member positioned between the countersink cutting member and the drive shank.

5. The drill bit according to claim 4, wherein the diameter of the counterbore cutting member is in the range of: 3.5 mm to 75.0 mm.

6. The drill bit according to claim 5, wherein the depth of the counterbore cutting member is in the range of: 1.6 mm to 48.0 mm.

7. The drill bit according to claim 4, wherein the diameter of the countersink cutting member is the in range of: 2.0 mm to 52.6 mm.

8. The drill bit according to claim 7, wherein the length of the countersink cutter is in the range of: 1.6 mm to 16 mm.

9. The drill bit according to claim 1, wherein the length of the first flute portion is in the range of: 19 mm to 120 mm.

10. The drill bit according to claim 1, wherein the drive shank comprises a quick-release bit holder.

11. The drill bit according to claim 1, wherein the drill bit is composed of one material selected from the following group of: carbon steel, and tungsten carbide.

12. The drill bill according to claim 3, wherein the first helix and the second helix is an angle chosen between the range of 10° to 45°.

13. The drill bit according to claim 12, wherein the first helix of the first flute portion has a different helix angle to the second helix of the second flute portion.

14. The drill bit according to claim 1, wherein the shape of the cutting tip comprises chamfered lines between the periphery of the cutting tip shape, when viewed axially above from the first end.

15. The drill bit according to claim 4, wherein a washer is positioned between the countersink cutting member and the drive shank.

16. The drill bit according to claim 4, wherein a washer is positioned between the counterbore cutting member and the drive shank.

17. The drill bit according to claim 15, wherein the washer having a first surface distal to the drive shank, and a second surface proximal to the drive shank, wherein the first surface is low surface friction.

18. The drill bit according to claim 17, wherein the first surface of the washer is one material chosen from the group of: nylon, plastic and Teflon.
